(19) United States
(12) Patent Application Publication
(10) Pub. No.: US 2017/0215583 A1
(43) Pub. Date: Aug. 3, 2017

(54) BOWL RACK

(71) Applicant: Robinson Home Products Inc., Williamsville, NY (US)

(72) Inventors: Lou Henry, Scarsdale, NY (US); John Healy, Brooklyn, NY (US)

(21) Appl. No.: 15/407,996

(22) Filed: Jan. 17, 2017

Related U.S. Application Data
(60) Provisional application No. 62/289,606, filed on Feb. 1, 2016.

(51) Int. Cl. A47B 81/04; A47L 19/04; A47J 47/16

(52) U.S. Cl. CPC A47B 81/04; A47J 47/16; A47L 19/04

(57) ABSTRACT

A bowl rack with a dual-sided body having a first working side, a second working side, a first end, a second end and opposed side walls and a deployable stop member, where each of the first and second working sides are configured to receive and retain the positioning of one or more bowls to be held while the other side is not in use.

### FIELD OF THE INVENTION

The present invention relates generally to kitchen organizers, and more specifically to a bowl rack for holding bowls of a variety of shapes and sizes for drying or storage.

### BACKGROUND OF THE INVENTION

Bowls are among one of the most commonly used articles in the kitchen. However, bowls may be difficult to store or dry vertically because of their varied shapes and sizes. Because of this, bowls are usually stored horizontally in a nested column after being washed and dried, or in a general purpose disk rack designed to hold an assortment of kitchen articles. However, there are significant limitations in both situations. Columns of bowls require stacking in accordance to shape and size and are prone to topple with increasing height and do not dry well in a stacked orientation. Also, disk racks are often bulky and can take up a significant portion of kitchen countertop, cabinet, drawer or shelf space.

Accordingly, there exists a need for a bowl rack that holds bowls of a variety of shapes and sizes and is compact for ease of storage.

### SUMMARY OF THE INVENTION

The present invention is directed to a bowl rack comprising a dual-sided body having a first working side, a second working side, a first end, a second end, opposed side walls with one or more support members therebetween, a series of retainer elements on each of the first and second working sides, and a deployable stop member on at least one of the first and second ends. The bowl rack is configured to receive and retain one or more bowls on one of the first side and the second side when that side is facing upwardly, while the other of the first side or second side is facing downwardly and not in use.

According to one aspect of the present invention, the dual-sided body defines a first side with a series of retainer elements that can be a series of detents, preferably on the top surfaces of the opposed side walls, with the deployable stop member providing a support for the first of the bowls stacked thereon. On this side, the edge of a bowl is supported between adjacent detents while the top or bottom of the bowl is rested against the deployable stop member.

The deployable stop member is mounted on at least one of the first and second ends of the dual-sided body, and preferably on one end, to provide a vertical support for an adjacent bowl to rest against when placed on the first side. The deployable stop member preferably comprises a “U” shape wire member with terminal ends pivotably attached to the first end of the dual-sided body, allowing the deployable stop member to extend perpendicularly from the bowl rack in a deployed configuration or to rest flat within an upper recess of the first side when in a stored configuration. Most preferably, the deployable stop member is removably mounted on the dual-sided body, so that it can be removed for cleaning.

The second side of the dual-sided body preferably includes lowered side walls with a series of retainer elements each comprising a hook to catch the lip of the bowl and hold the bowl in a vertical orientation, when the second side faces upwardly, without the need for a stop member. The hook shaped retainer members permit the retention of different sized bowls, since there is no need for the bowls to rest against adjacent bowls when placed in a vertical orientation on the second side of the dual-sided body.

Optionally, the first and second sides may have non-skid materials applied to the lowermost surface when the sides are facing downwardly, to prevent the bowl rack from sliding across a countertop or other smooth surface. The non-skid material can be molded onto or applied to the first and/or second sides, directly onto the first end, second end or opposed side walls or onto feet that extend from the bowl rack.

### BRIEF DESCRIPTION OF THE DRAWINGS

FIG. 1 is an exploded perspective view of an embodiment of the bowl rack of the present invention.

FIG. 2 is a perspective view of an embodiment of the bowl rack of the present invention, with the deployable stop member in a folded configuration.

FIG. 3 is a side elevation of an embodiment of the bowl rack of the present invention with the first side in an upward facing orientation.

FIG. 4 is a front elevation of an embodiment of the bowl rack of the present invention.

FIG. 5 is a bottom plan view of an embodiment of the bowl rack of the present invention.

FIG. 6 is a cross-sectional side view of the bowl rack of the present invention, with the second side of the dual-sided body facing upward.

FIG. 7A is a cross-sectional side view of the bowl rack of the present invention, with the first side of the dual-sided body facing upward.

FIG. 7B is a partial cross-sectional side view of a support member of the bowl rack of the present invention.

FIG. 8 is a top plan view of the second side of the dual-sided body of the bowl rack of the present invention.

FIG. 9 is a perspective view of an embodiment of the bowl rack of the present invention with the first side facing upward and the deployable stop member detached.

FIG. 10 is a front elevation of the preferred deployable stop member of the present invention in a vertical configuration.

FIG. 11 is a perspective view of the preferred deployable stop member of the bowl rack of the present invention.

FIG. 12 is a bottom plan view of the preferred deployable stop member of the bowl rack of the present invention.

FIG. 13 is a side elevation of the preferred deployable stop member of the present invention.

### DETAILED DESCRIPTION

The present invention is now described with reference to figures which indicate identical or functionally similar elements. While specific configurations and arrangements are discussed, it should be understood that this is done for illustrative purposes only. A person skilled in the relevant art will recognize that other configurations and arrangements can be used without departing form the spirit and scope of the invention.

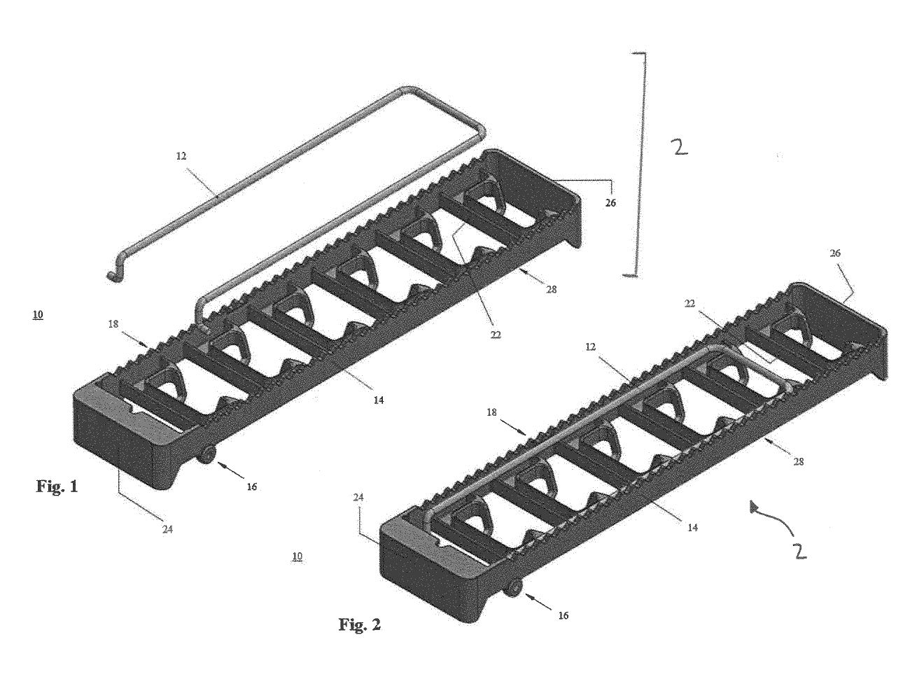

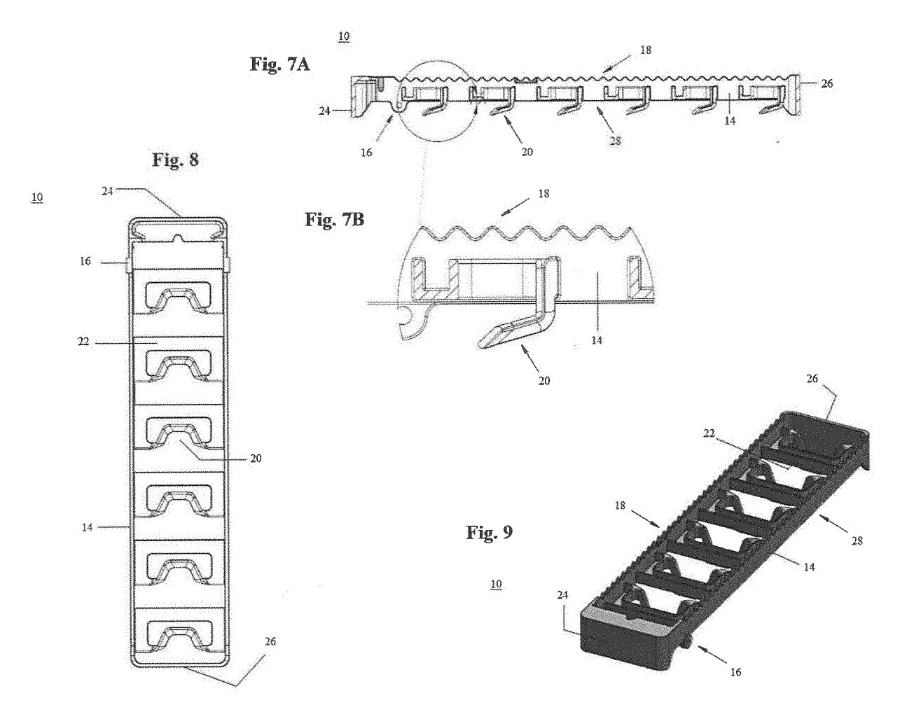

In a preferred embodiment, shown in the accompanying drawings, and particularly FIGS. 1-9, the bowl rack 10 is comprises a dual-sided body 2 having a first working side 18 and a second working side 28, a first end 24 and a second end 26, and opposed side walls 14 with a plurality of support members 22 between the opposing side walls 14 at fixed distances from the first end 24 and the second end 26. A deployable stop member 12 pivotably attached at the first end 24 to act as a support for resting a first bowl placed on the first side 18 of the bowl rack 10. The first side 18 and second side 28 are each side configured to receive and retain one or more bowls in a vertical orientation when the respective side is facing upwardly and the other side is not in use.

The first side 18 preferably has a non-slip surface, formed of a non-slip material, with a series of protrusions, a series of indentations or combination thereof on the terminal surfaces of the opposed side walls 14, on which the edge of the bowls are placed, with a recess between the opposed side walls 14 into which the circumference of the bowl is allowed to extend. The deployable stop member 12 is mounted on the first end 24 of the first side 18 of the dual-sided body at pivoting portions 16, such that the deployable stop member 12 can pivot from a stored orientation within the opposed side walls 14 to a deployed orientation substantially perpendicular to the top surface of the first side 18.

The deployed deployable stop member 12 serves as a vertical support for the first bowl placed on the top surfaces of the opposed side walls 14, with subsequent bowls resting on the adjacent bowl. Preferably, the length of the deployable stop member 12 does not exceed the length of the dual-sided body from the first end 24 to the second end 26, so that the stored deployable stop member 12 fits within the dual sided body, as shown in FIG. 2.

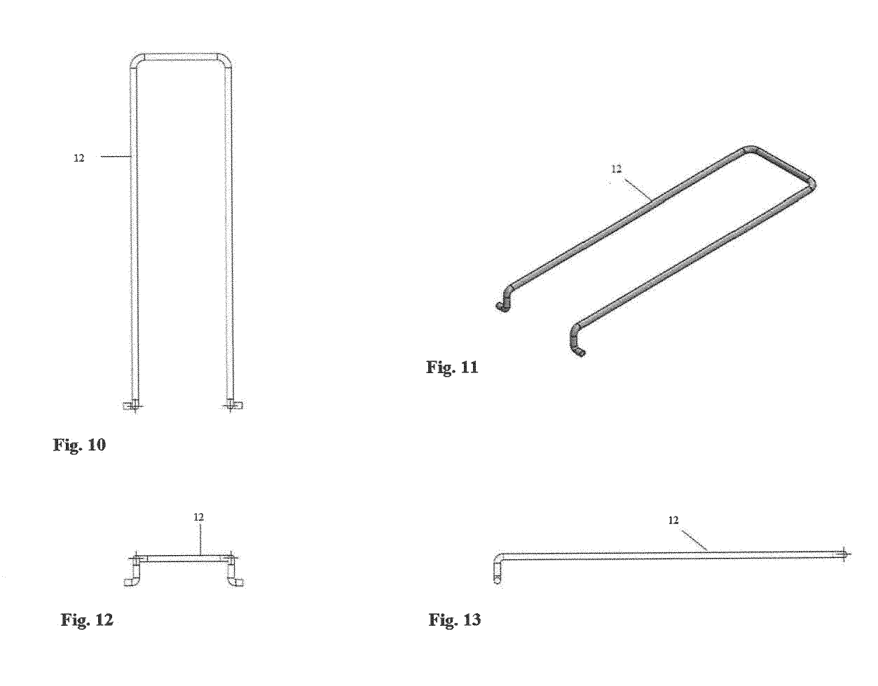

As best seen in FIGS. 1, 2 and 10-13, the deployable stop member 12 preferably comprises a “U” shape wire member with terminal ends that engage the dual-sided body at pivoting portions 16 in the area of the first end 24. The preferably deployable stop member 12 may be detached from the dual-sided body as desired for cleaning and replacement. The deployable stop member 12 may be composed of any suitable substantially rigid and durable material such as aluminum, fiberglass, metal, plastic, steel, and/or wood. A preferred material for the deployable stop member 12 is steel, and more preferably stainless steel.

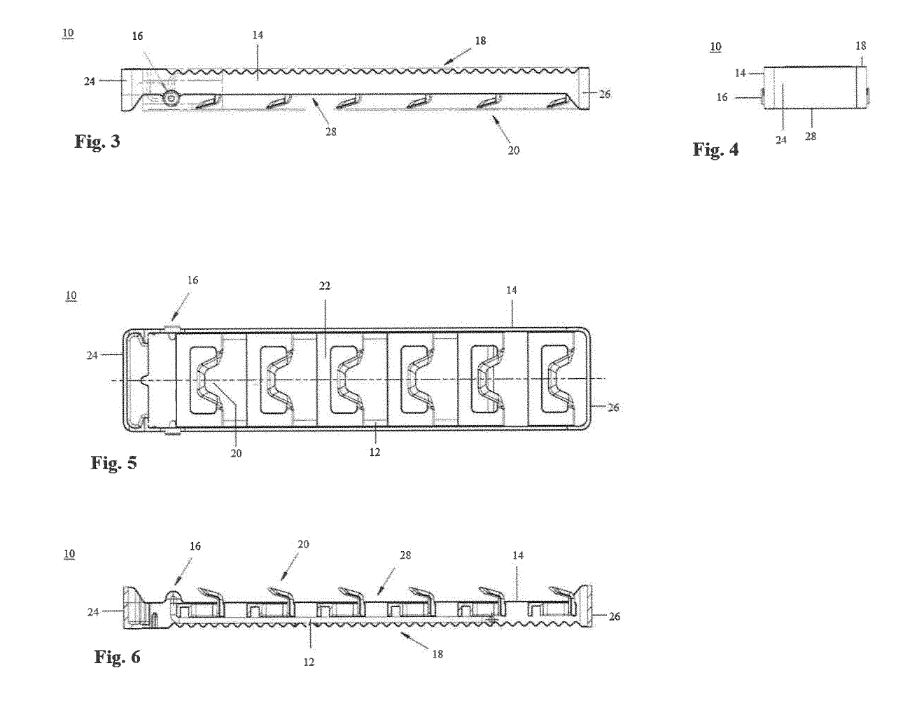

Referring to FIGS. 3 and 5-8, the second side 28 features lowered opposed side walls 14, permitting the upper ends of a series of hooks 20 to rise above the opposed side walls 14 and to retain the edges of one or more bowls. Preferably, the series of hooks 20 are associated with the support members 22 that act to provide structural integrity to the opposed side walls 14. The base of the hooks 20 are preferably fixed to the support members 22, pass above the opposing side walls 14, and turn toward the first end 24 at a fixed angle, thus forming hooks 20, for catching hold or hanging onto the one or more bowls place on the opposed side walls 14. With this configuration, the edges of the bowls can slip within the hooks 20, such that the hooks 20 can hold the bowls in a substantially vertical orientation without a separate stop member to rest the bowls against.

The height of the hooks 20 does not exceed the height of the dual-sided body at the first end 24 and the second end 26, to permit the dual-sided body 2 to rest on the first and second ends 24, 26 without interference from the hooks 20. In the preferred embodiment, the bowl rack 10 has a series of six hooks spaced along the length of the rack 10. The hooks 20 can be made of any suitable material such as rubber, neoprene, polyurethane, vinyl, silicone or like materials, however, it is preferred that the hooks 20 are made of the same material as the entire dual-sided body 2.

The first end 24, second end 26, opposing side walls 14, and support members 22 of the dual-sided body may be composed of any suitable substantially rigid and durable material such as glass, stainless steel, aluminum and/or plastic, preferably plastic, and more preferably an acrylonitrile butadiene styrene (“ABS”). In the most preferred embodiment, the dual-sided body 2 is made of a single material, such that the components of the dual-sided body 2 are integrally formed in a single mold for efficiency of manufacture.

While an exemplary embodiment has been described and shown in the accompanying drawings, it is to be understood that this embodiment is merely illustrative and not restrictive of the current invention, and that this invention is not restricted to the specific constructions and arrangements shown and described, since modifications can occur to those of ordinary skill in the art. All such variations, modifications and/or alternatives are intended to fall within the scope of the present invention.

The terms “comprising” or “comprises” as used in the following claims are open-ended transitional terms that are intended to include additional elements not specifically recited in the claims.

It should be noted that it is envisioned that any feature or element that is positively identified in this document may also be specifically excluded as a feature or element of an embodiment of the present invention.

1. A bowl rack, comprising a dual-sided body having a first working side and a second working side, a first end and a second end, and opposed side walls, wherein each of said first side and said second working side is configured to hold one or more bowls when said side is in a upward facing orientation and the other side is not in use, a deployable stop member associated with the first side and a plurality of hooks associated with the second side.

2. The bowl rack of claim 1, wherein the terminal surface of the opposed side walls on the first side comprises a non-slip surface taken from the group consisting of a non-slip material, a series of protrusions, a series of indentations and combinations thereof.

3. The bowl rack of claim 1, wherein the deployable stop member comprises cooperating ends that engage pivoting portions on the dual-sided body that provide for transition from a deployed orientation, substantially perpendicular to the first working side, to a stored orientation, substantially parallel to the first working side.

4. The bowl rack of claim 3, wherein the deployable stop member fits within the opposed side walls on the first side of the dual sided body when in its stored orientation.

5. The bowl rack of claim 1, wherein the first side further comprises a recess between the opposed side walls.

6. The bowl rack of claim 1, wherein the second side of the dual-sided body comprises a plurality of hooks.

7. The bowl rack of claim 6, wherein at least a portion of the hooks extend above the opposed side walls on the second working side.

8. The bowl rack of claim 1, wherein the second working side of the dual-sided body further comprises a recess between the opposed side walls.

9. The bowl rack of claim 6, wherein the hooks on the second side do not extend above a height of the first and second ends of the dual-sided body when the second side is facing upwardly.

10. The bowl rack of claim 1, wherein the dual-sided body further comprises a series of support members between the opposed side walls.

11. The bowl rack of claim 10, wherein the second side of the dual-sided body comprises a plurality of hooks extending from the support members.

12. The bowl rack of claim 1, wherein at least a portion of the dual-sided body is made of acrylonitrile butadiene styrene plastic.

13. The bowl rack of claim 1, wherein the dual-sided body is integrally formed of acrylonitrile butadiene styrene plastic.

14. The bowl rack of claim 1, wherein the deployable stop member is made of a material taken from the group consisting of aluminum, fiberglass, metal, plastic, steel, wood or combinations thereof.

15. The bowl rack of claim 1, wherein the deployable stop member is made of stainless steel.

16. The bowl rack of claim 1, wherein the deployable stop member is removably attached to the dual-sided body.
